(19) United States
(12) Patent Application Publication
(10) Pub. No.: US 2025/0082975 A1
(43) Pub. Date: Mar. 13, 2025

(54) ENERGY STORAGE APPARATUS AND ENERGY STORAGE SYSTEM

(71) Applicant: SUNGROW POWER SUPPLY CO., LTD., Hefei (CN)

(72) Inventor: Yunfang CHENG, Hefei (CN)

(21) Appl. No.: 18/820,320

(22) Filed: Aug. 30, 2024

(30) Foreign Application Priority Data
Sep. 7, 2023 (CN) 202322441726.6

(51) Int. Cl. A62C 3/16; A62C 31/00; A62C 37/36

(52) U.S. Cl. CPC A62C 3/16; A62C 31/005; A62C 37/04

(57) ABSTRACT

The present disclosure discloses an energy storage apparatus and an energy storage system, which belongs to the field of energy storage technologies. The energy storage apparatus includes a box, a water supply pipeline, at least one heat generation module, and water outlet portion. The at least one heat generation module is mounted in the box. Each of the at least one heat generation module includes a plurality of heat generation devices arranged at intervals to form a corresponding heat generation region. The water supply pipeline is mounted at the box. The water outlet portion is disposed at the box and corresponds to the heat generation region. The water outlet portion is in communication with a water outlet end of the water supply pipeline and configured to spray water in a sweeping motion to the heat generation region corresponding to the water outlet portion.

### CROSS-REFERENCE TO RELATED APPLICATION

This application claims priority to Chinese Patent Application No. 202322441726.6, filed on Sep. 7, 2023, which is hereby incorporated by reference in its entirety.

### FIELD

The present disclosure relates to the field of energy storage technologies, and more particularly, to an energy storage apparatus and an energy storage system.

### BACKGROUND

An energy storage system is a highly integrated device with a plurality of groups of battery modules placed inside a box of the energy storage system, which has characteristics of high integration, small footprint, flexible mounting, and good mobility and expandability. When the energy storage system has an excessively high internal temperature, it is prone to temperature control loss, causing a fire. An existing energy storage system is often provided with a sprinkler head at a top of each battery module to ensure fire safety. However, the battery module is usually formed by a plurality of battery packs stacked to each other, and water spraying range and distance of the sprinkler head are limited, resulting in the inability to spray the plurality of battery packs of the battery module. Firefighting is delayed and safety is poor, so that the fire cannot be extinguished timely, which seriously affects safety of the energy storage system.

### SUMMARY

The present disclosure aims to solve at least one of the technical problems in the related art. To this end, the present disclosure provides an energy storage apparatus and an energy storage system. By providing a water supply pipeline and water outlet portion that is capable of spraying water in a sweeping motion to a heat generation region, the heat generation device experiencing thermal runaway can thus be sprayed with water to extinguish a fire timely, reducing a scope and loss of the fire, ensuring safety of the energy storage apparatus.

In a first aspect, the present disclosure provides an energy storage apparatus. The energy storage apparatus includes a box, at least one heat generation module, a water supply pipeline, at least one water outlet portion. The at least one heat generation module is mounted in the box. Each of the at least one heat generation module includes a plurality of heat generation devices arranged at intervals to form a corresponding heat generation region. The water supply pipeline is mounted at the box. The at least one water outlet portion is disposed at the box and corresponds to the heat generation region. Each of the at least one water outlet portion is in communication with a water outlet end of the water supply pipeline and configured to spray water in a sweeping motion to the heat generation region corresponding to the water outlet portion.

In the energy storage apparatus according to the present disclosure, when the at least one heat generation device experiences the thermal runaway, since the water outlet portion is in communication with the water outlet end of the water supply pipeline, and the water outlet portion is configured to spray the water in the sweeping motion to the heating region, the heat generation device experiencing the thermal runaway can be sprayed with the water to extinguish the fire timely, reducing the scope and the loss of the fire, ensuring the safety of the energy storage apparatus.

According to an embodiment of the present disclosure, the water outlet portion includes at least one water spraying head rotatably disposed in the box and configured to spray water to at least two of the plurality of heat generation devices in the heat generation region corresponding to the water outlet portion.

According to an embodiment of the present disclosure, each of the at least one water spraying head includes a main portion and a plurality of blades circumferentially arranged at an outer wall of the main portion. The main portion is rotatably disposed in the box, the main portion defining a main cavity. The main cavity is in communication with the water outlet end of the water supply pipeline. Each of the plurality of blades has an auxiliary cavity in communication with the main cavity. Each of the plurality of blades has at least one water spray hole at a surface of the blade, and the at least one water spray hole is in communication with the auxiliary cavity.

According to an embodiment of the present disclosure, the water outlet portion includes a plurality of water spraying heads arranged at intervals in a direction in which the plurality of heat generation devices is arranged.

According to an embodiment of the present disclosure, the water outlet portion includes a plurality of water outlet holes arranged at the water supply pipeline at intervals in a direction in which the plurality of heat generation devices is arranged, where 1<A<M, where A represents a total number of water spraying heads of the water outlet portion, and M represents a total number of the heat generation devices in the heat generation region corresponding to the water outlet portion.

According to an embodiment of the present disclosure, a plurality of heat generation modules and a plurality of water outlet portions are provided, the plurality of heat generation modules are in a one-to-one correspondence with the plurality of water outlet portions, and the plurality of water outlet portions are arranged at intervals in a direction in which the plurality of heat generation modules is arranged.

According to an embodiment of the present disclosure, the water supply pipeline includes a water delivery pipeline and a plurality of water spraying pipelines. The plurality of water spraying pipelines is in a one-to-one correspondence with the plurality of heat generation modules. Each of the plurality of water spraying pipelines has a water outlet end in communication with a water outlet portion and a water inlet end in communication with a water outlet end of the water delivery pipeline.

According to an embodiment of the present disclosure, the water supply pipeline includes a water delivery pipeline and a water spraying pipeline. The water spraying pipeline is of zigzag shape. Each of the plurality of water outlet portions is in communication with a water outlet end of the water spraying pipeline, and the water spraying pipeline having a water inlet end is in communication with a water outlet end of the water delivery pipeline.

According to an embodiment of the present disclosure, the energy storage apparatus further includes at least one detector, a water supply pump, and a controller. The at least one detector is disposed in the box and configured to detect environmental information of at least one heat generation region. The water supply pump is configured to drive water to flow into the water supply pipeline. The controller is electrically connected to the detector and the water supply pump. The controller is configured to control the water supply pump based on the environmental information.

A second aspect, the present disclosure provides an energy storage system. The energy storage system includes a power generator and the energy storage apparatus described above. The energy storage apparatus is electrically connected to the power generator.

In the energy storage apparatus according to the present disclosure, since the water supply pipeline and the water outlet portion are arranged at the energy storage apparatus, and the water outlet portion can spray the water in the sweeping motion to the heating region, the heat generation device experiencing the thermal runaway can be sprayed with the water to extinguish the fire timely, reducing the scope and the loss of the fire, ensuring the safety of the energy storage apparatus.

### BRIEF DESCRIPTION OF THE DRAWINGS

These and other aspects and advantages of embodiments of the present disclosure will become apparent and more readily appreciated from the following descriptions made with reference to the accompanying drawings.

FIG. 1 is a first schematic structural view of a first energy storage apparatus according to an embodiment of the present disclosure.

FIG. 2 is one of the schematic structural views of a water spraying head of the first energy storage apparatus according to an embodiment of the present disclosure.

FIG. 3 is a schematic structural view of a second energy storage apparatus according to an embodiment of the present disclosure.

FIG. 4 is a second schematic structural view of a first energy storage apparatus according to an embodiment of the present disclosure.

FIG. 5 is a third schematic structural view of a first energy storage apparatus according to an embodiment of the present disclosure.

### REFERENCE NUMERALS

111, water injection opening;
120, heat generation module;
130, water supply pipeline; 131, water delivery pipeline; 132, water spraying pipeline;
141, water spraying head; 1411, main portion; 1412, blade; 1413, water spraying hole; 142, water outlet hole;
150, detector; 160, water supply pump; 170, valve group.

### DETAILED DESCRIPTION

The embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain rather than limit the present disclosure.

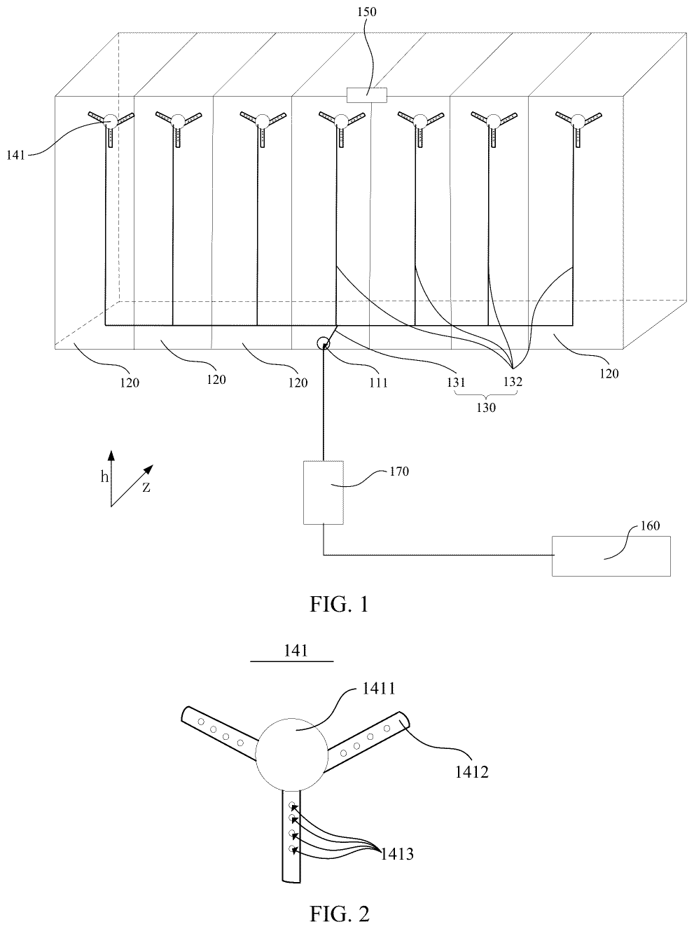

Referring to FIGS. 1 to 5, an energy storage apparatus according to an embodiment of the present disclosure is described below. The energy storage apparatus includes a box, a water supply pipeline 130, at least one heat generation module 120, and a water outlet portion.

The box has a water injection opening 111. A material of the box includes but is not limited to stainless steel, aluminum alloy or titanium alloy. In this embodiment, the water injection opening 111 is located at a bottom of the box to facilitate an internal layout of the box. It should be noted that a shape, a size, and a specific position of the water injection opening 111 can be adjusted based on actual conditions, which is not limited in this embodiment.

It can be understood that if a water tank is placed in the box, no water injection opening 111 is required for the box, and sealing performance of the energy storage apparatus can be further improved.

At least one heat generation module 120 is mounted in the box, and each of the least one heat generation module 120 includes a plurality of heat generation devices arranged at intervals to form a corresponding heating region.

It should be noted that, in this embodiment, the heat generation module 120 includes a battery module, and the battery module includes a plurality of battery packs arranged at intervals to provide and store large-capacity electric energy, that is, the heat generation device includes the battery pack. In some embodiments, the heat generation module 120 further includes an electronic device module. The electronic device module includes a plurality of electronic devices arranged at intervals, that is, the heat generation device further includes the electronic device. The electronic device includes but is not limited to current transformers, capacitors, inductors, copper bars, contactors, circuit breakers, and the like. It can be understood that whether the battery pack or the electronic device, a large amount of heat is generated continuously during normal operation, which not only affects their own heat, but also increases an operation temperature of an adjacent battery pack or electronic device, resulting in an increased temperature in the corresponding heat generation module 120, thus increasing an overall temperature of the heating region with a risk of the thermal runaway.

In this embodiment, the plurality of heat generation devices is arranged at intervals in a height direction h of the heat generation device. It should be understood that a number and arrangement of the heat generation devices and a number of the heat generation modules 120 can be designed based on actual conditions, which is not limited in this embodiment.

The water supply pipeline 130 is mounted in the box. A material of the water supply pipeline 130 includes, but is not limited to, stainless steel, copper, plastic, etc. When the box has the water injection opening, the water supply pipeline 130 has a water inlet end at the water injection opening 111 and configured to be in communication with an ambient environment.

It can be understood that the water inlet end of the water supply pipeline 130 is in communication with the ambient environment through the water injection opening 111, and therefore water can be delivered into the box from the ambient environment timely to extinguish the fire timely when the thermal runaway occurs in the heat generation region. In some embodiments, the water supply pipeline 130 is arranged in the box in a concealed layout out of consideration for aesthetically pleasing appearance and integration of the energy storage apparatus.

The water outlet portion is disposed in the box. The water outlet portion is in communication with the water outlet end of the water supply pipeline 130 and corresponds to the heat generation region. The water outlet portion is configured to spray water in a sweeping motion to the heat generation region corresponding to the water outlet portion.

It should be noted that the spraying the water in the sweeping motion refers to all the heat generation devices in the heat generation region are sprayed with water in sequence based on a certain rule, or are sprayed with water simultaneously.

It can be understood that when the at least one heat generation device experiences the thermal runaway, since the water outlet portion is in communication with the water outlet end of the water supply pipeline 130, and the water outlet portion can spray the water in the sweeping motion to the heat generation region, the heat generation device experiencing the thermal runaway can be sprayed with the water to extinguish the fire timely, reducing the scope and the loss of the fire, ensuring the safety of the energy storage apparatus.

In this embodiment, considering that the plurality of heat generation devices of the heat generation module 120 is arranged at intervals in the height direction h, the water outlet portion is located outside a side wall of the heat generation module 120. In some embodiments, if the plurality of heat generation devices is arranged at intervals in a length direction or a width direction of the electronic device, the water outlet portion may also be located above the heat generation module 120, which is not specifically limited in this embodiment.

In the energy storage apparatus according to the embodiments of the present disclosure, by providing the water supply pipeline 130 and the water outlet portion that can spray the water in the sweeping motion to the heat generation region, the heat generation device experiencing the thermal runaway can thus be sprayed with the water to extinguish the fire timely, reducing the scope and the loss of the fire, ensuring the safety of the energy storage apparatus.

In some embodiments, in order to spray water in a sweeping motion to the heat generation region, this embodiment provides two types of the water outlet structures.

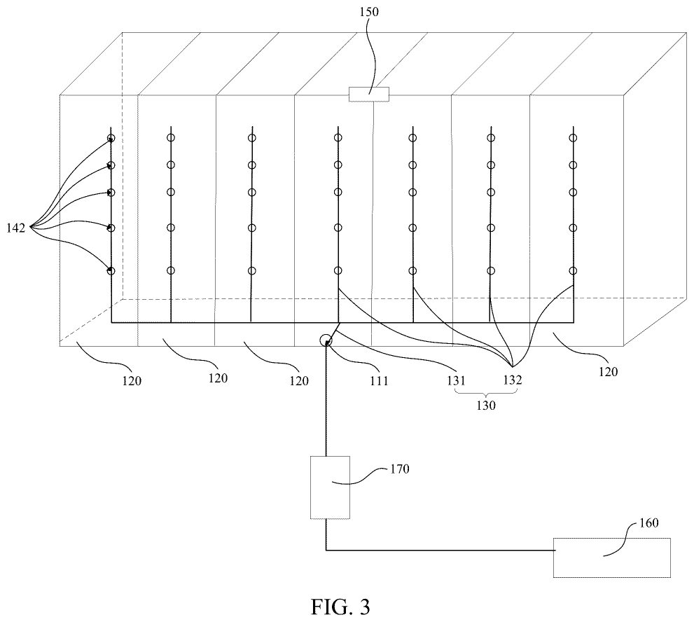

For the first type, as illustrated in FIG. 3, the water outlet portion includes a plurality of water outlet holes 142. The plurality of water outlet holes 142 is arranged at the water supply pipeline 130 at intervals in a direction in which the plurality of heat generation devices is arranged. That is, an output end of the water supply pipeline 130 is composed of a plurality of water outlet holes 142. The plurality of water outlet holes 142 sprays water simultaneously, each of the plurality of water outlet holes 142 sprays water to a heat generation device it faces, thereby ensuring that the water outlet portion can spray water to each heat generation device of the heat generation module 120 simultaneously. It should be noted that a number and a shape of water outlet holes 142 can be designed based on actual conditions, which is not specifically limited in this embodiment.

For the second type, as illustrated in FIGS. 1, 4, and 5, the water outlet portion includes at least one water spraying head 141. The water spraying head 141 may be rotatably disposed in the box and configured to spray water to at least two heat generation devices in the corresponding heat generation region. It can be understood that, since the water spraying head 141 is rotatably disposed in the box, a water spraying range of the water spraying head 141 can be widened and adjusted by using a rotation and a rotation speed change of the water spraying head 141 to accurately extinguish the fire for the heat generation device experiencing the thermal runaway in the heat generation region. It should be noted that, considering that the water outlet portion is disposed outside the side wall of the heat generation module 120, the water spraying head 141 in this embodiment rotates around an axis direction z.

It should be noted that the water spraying range of the water spraying head 141 is widened by using the rotation of the water spraying head 141, and therefore the water spraying head 141 can spray water to at least two heat generation devices. Thus, a number of water spraying heads 141 required for each heat generation region can be reduced, ensuring a fire fighting effect while reducing fire fighting cost.

In some embodiments, a rotation axis of the water spraying head 141 is adjustable to further adjust the water spraying range of the water spraying head 141, improving accuracy of the water spraying.

In this embodiment, as illustrated in FIG. 2, the water spraying head 141 includes a main portion 1411 and a plurality of blades 1412 circumferentially arranged at an outer wall of the main portion 1411. The main portion 1411 is rotatably disposed in the box and defined a main cavity. The main cavity is in communication with the water outlet end of the water supply pipeline 130. Each of the plurality of blades 1412 has an auxiliary cavity in communication with the main cavity and has at least one water spraying hole 1413 at a surface of the blade 1412. The water spraying hole 1413 is in communication with the auxiliary cavity. It can be understood that water flows into the main cavity from the output end of the water supply pipeline 130, and evenly flows into each auxiliary cavity, and then is sprayed from the corresponding spray hole 1413, thereby spraying the water in the sweeping motion to the heat generation region. It should be noted that a number and a shape of the blades 1412 and a number and arrangement of the water spraying holes 1413 can be designed based on actual conditions, which is not specifically limited in this embodiment.

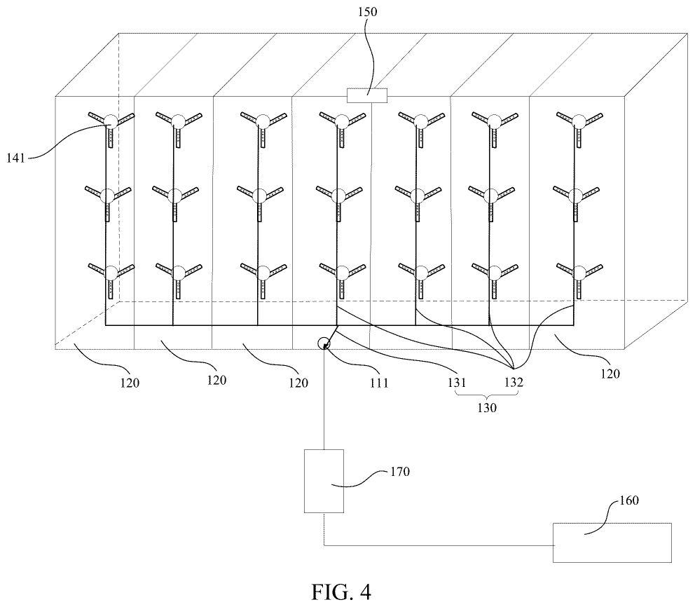

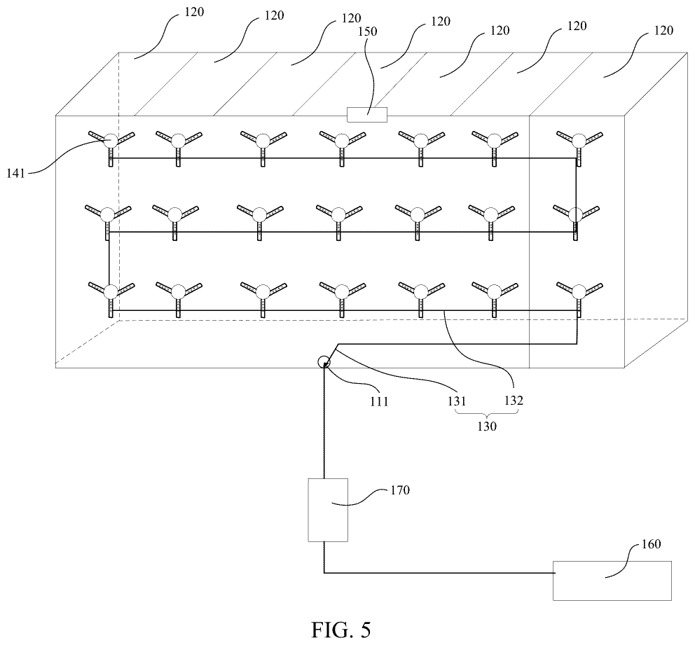

As illustrated in FIGS. 4 and 5, in some embodiments, each water outlet portion includes a plurality of water spraying heads 141 arranged at intervals in a direction in which the plurality of heat generation devices is arranged. It can be understood that, since each heat generation region has the plurality of heat generation devices, the plurality of water spraying heads 141 is arranged at intervals in the direction in which the plurality of heat generation devices is arranged, to further control a uniform water spraying amount of the water spraying portion for each heat generation device, ensuring a fire extinguishing effect. It should be noted that since each water spraying head 141 can spray the water on the at least two heat generation devices, the number of water spraying heads 141 required in each heat generation region is smaller than the number of heat generation devices, i.e. 1<A<M, where A represents a total number of water spraying heads 141 of the water outlet portion, and M represents a total number of the heat generation devices in the heat generation region corresponding to the water outlet portion. In this way, the fire fighting effect is reduced while reducing the fire fighting cost as much as possible.

In some embodiments, as illustrated in FIGS. 1 and 3 to 5, in order to improve operation efficiency and energy storage capacity of the energy storage apparatus, a plurality of heat generation modules 120 and a plurality of water outlet portions are both provided. The plurality of heat generation modules 120 is in a one-to-one correspondence with the plurality of water outlet portions, and the plurality of water outlet portions is arranged at intervals in a direction in which the plurality of heat generation modules 120 is arranged.

In this embodiment, the plurality of heat generation modules 120, i.e., the battery modules, is arranged at intervals in the horizontal direction, and the water outlet portions are also arranged at intervals in the horizontal direction, i.e., each water outlet portion faces a battery module, thereby ensuring that each water outlet portion can spray the water in the sweeping motion to the heat generation region formed by the corresponding battery module, and ensuring the fire fighting safety of the whole energy storage apparatus. It can be understood that a number and arrangement of the heat generation modules 120 can be designed based on the actual situation, which is not specifically limited in this embodiment.

In some embodiments, as illustrated in FIGS. 1 and 3 to 5, the water supply pipeline 130 includes a water delivery pipeline 131 and a water spraying pipeline 132. The water spraying pipeline 132 has a water outlet end in communication with the water outlet portion and a water inlet end in communication with a water outlet end of the water delivery pipeline 131. That is, water flows into the water delivery pipeline 131 from the water inlet end of the water delivery pipeline 131, then flows into the water spraying pipeline 132 from the water outlet end of the water delivery pipeline 131 through the water inlet end of the water spraying pipeline 132, and finally is directly sprayed out from the water outlet hole 142 of the water spraying pipeline 132, or is sprayed out from the water spraying hole 1413 of the water spraying head 141 through the water outlet end of the water spraying pipeline 132. It should be noted that, when the box has no water injection opening, the water inlet end of the water delivery pipeline 131 is located at the water injection opening 111.

In some embodiments, when a plurality of water outlet portions and a plurality of heat generation modules 120 are provided, as illustrated in FIGS. 1, 3, and 4, a plurality of water spraying pipelines 132 is provided, the plurality of water spraying pipelines 132 is in a one-to-one correspondence with the plurality of heat generation modules 120, each of the plurality of water spraying pipelines 132 has a water outlet end in communication with a water outlet portion and a water inlet end in communication with a water outlet end of the water delivery pipeline 131. That is, the plurality of water spraying pipelines 132 is connected in parallel to ensure that each water outlet portion can spray water in a sweeping motion to the corresponding heat generation region simultaneously, and to facilitate maintenance.

In some embodiments, when a plurality of water outlet portions and a plurality of heat generation modules 120 are provided, as illustrated in FIG. 5, a water spraying pipeline 132 may also be of zigzag shape, and each of the plurality of water outlet portions is in communication with a water outlet end of the water spraying pipeline 132. That is, the water outlet portions are connected in series, which can reduce difficulty in laying out the water spraying pipeline 132 and the water delivery pipeline 131, and can improve mounting efficiency.

It should be noted that, if a plurality of heat generation modules 120 is provided and corresponding heat generation regions are in communication with each other, a plurality of water spraying pipelines 132 may be provided to allow a plurality of water outlet portions to be connected in parallel, or the water spraying pipelines 132 may be of zigzag shape to allow a plurality of water outlet portions to be connected in series; and if the plurality of heat generation regions is independent from each other, only a plurality of water spraying pipelines 132 may be provided to allow a plurality of water outlet portions to be connected in parallel.

In some embodiments, as illustrated in FIGS. 1 and 3 to 5, the energy storage apparatus further includes a water supply pump 160, a controller, and at least one detector 150. The detector 150 is disposed in the box and is configured to detect environmental information of at least one heat generation region. The water supply pump 160 is configured to drive water to flow into the water supply pipeline 130. The controller is electrically connected to the detector 150 and the water supply pump 160 and is configured to control the water supply pump 160 based on the environmental information.

It should be noted that the environmental information includes a temperature, a smoke concentration, a carbon monoxide (CO) concentration, a volatile organic compounds (VOC) concentration, and a hydrogen (H2) concentration. A number and specific arrangement of the detectors 150 can be designed based on actual situations, which is not specifically limited in this embodiment.

It can be understood that, when the environmental information detected by the detector 150 meets a predetermined condition including but is not limited to a temperature of the heat generation region being higher than a first threshold, the smoke concentration being higher than a second threshold, the CO concentration being higher than a third threshold, the VOC concentration being higher than a fourth threshold, and the H2 concentration being higher than a fifth threshold, an alarm signal is sent to the controller, and the controller controls the water supply pump 160 based on the received alarm signal to allow the water outlet portion to spray water in a sweeping motion to the heat generation region; and when the environmental information detected by the detector 150 does not meet the predetermined condition, the detector 150 sends a stop signal to the controller, and the controller controls the water supply pump 160 based on the received stop signal to allow the water outlet portion stop spraying water in a sweeping motion to the heat generation region, thereby satisfying water resource saving.

It should be noted that the detector 150 includes, but is not limited to, a heat detector 150, a smoke detector 150, a smoke and heat fire detector 150 or a temperature, smoke, CO, VOC, and hydrogen five-in-one composite intelligent fire detector 150. The controller includes, but is not limited to, a Programmable Logic Controller (PLC), a Distributed Control System (DCS), an intelligent controller, or a modular controller.

In this embodiment, the controller controls on/off and frequency of the water supply pump 160 through a valve group 170, and the frequency of the water supply pump 160 is related to a flow rate of water. When the controller controls the frequency of the water supply pump 160 to be increased, the flow rate of the water is increased, and the water spraying effect of the water outlet portion is enhanced. When the controller controls the frequency of the water supply pump 160 to be decreased, the flow rate of the water is decreased, and the water spraying effect of the water outlet portion is weakened.

In some embodiments, the controller is electrically connected to the water outlet portion to control operation of at least one water outlet portion, thereby avoiding spraying water to all the heat generation regions simultaneously, further reducing water consumption and improving the fire extinguishing accuracy. When the water outlet portion includes a water spraying head 141, the controller can also control rotation speed and an angle of a rotation axis of the water spraying head 141 to further improve the fire extinguishing efficiency and effect.

An embodiment of the present disclosure further provides an energy storage system. The energy storage system includes a power generator and the energy storage apparatus described above.

The power generator may include, but is not limited to, a photovoltaic power generator, a hydroelectric power generator, a wind power generator or a tidal power generator, which is not specifically limited in this embodiment.

In the energy storage system according to the embodiment of the present disclosure, the water supply pipeline 130 and the water outlet portion are disposed in the energy storage apparatus, and the water outlet portion can spray the water in the sweeping motion to the heat generation region, the heat generation device experiencing the thermal runaway can thus be sprayed with the water to extinguish the fire timely, reducing the scope and the loss of the fire, ensuring the safety of the energy storage apparatus.

Terms such as “first”, “second”, etc., in the specification and claims of the present disclosure are used to distinguish similar objects, rather than to describe a specific sequence or order. It should be understood that data used in this way can be interchanged with each other under appropriate circumstances, such that the described embodiments of the present disclosure can be implemented in a sequence other than those illustrated in the figures or described in the present disclosure, and the “first”, the “second”, etc., delineate objects of a kind, without restricting a quantity of the objects, for example, a first object may be one or more. Moreover, in the specification and claims of the present disclosure, a term “and/or” means at least one of the connected objects, and a character “/” generally means a “or” relationship between the associated objects.

In the description of the present disclosure, it is to be understood that, terms such as “center”, “longitudinal”, “lateral”, “length”, “width”, “thickness”, “over”, “below”, “front”, “back”, “left”, “right”, “vertical”, “horizontal”, “top”, “bottom”, “in”, “out”, “clockwise”, “anti-clockwise”, “axial”, “radial” and “circumference” refer to the directions and location relations which are the directions and location relations shown in the drawings, and for describing the present disclosure and for describing in simple, and which are not intended to indicate or imply that the device or the elements are disposed to locate at the specific directions or are structured and performed in the specific directions, which could not to be understood to the limitation of the present disclosure.

In the description of the present disclosure, “first characteristic”, “second characteristic” may include one or more such characteristics.

In the description of the present disclosure, “plurality of” means two or more than two.

In the description of the present disclosure, the first characteristic is “on” or “under” the second characteristic refers to the first characteristic and the second characteristic can be direct or via their another characteristic indirect mountings, connections, and couplings.

In the description of the present disclosure, the first characteristic is “on”, “above”, “over” the second characteristic may refer to the first characteristic is right over the second characteristic or is diagonal above the second characteristic, or just refer to the horizontal height of the first characteristic is higher than the horizontal height of the second characteristic.

In the description of this specification, descriptions with reference to the terms “an embodiment”, “some embodiments”, “an exemplary embodiment”, “an example”, “a specific example”, or “some examples” etc., mean that specific features, structure, materials or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or more embodiments or examples in a suitable manner.

Although embodiments of the present disclosure have been illustrated and described, it is conceivable for those of ordinary skill in the art that various changes, modifications, replacements, and variations can be made to these embodiments without departing from the principles and spirit of the present disclosure. The scope of the present disclosure shall be defined by the claims as appended and their equivalents.

What is claimed is:

1. An energy storage apparatus, characterized in comprising:
a box;
at least one heat generation module mounted in the box, each of the at least one heat generation module comprising a plurality of heat generation devices arranged at intervals to form a corresponding heat generation region;
a water supply pipeline mounted at the box; and
at least one water outlet portion disposed at the box and corresponding to the heat generation region, each of the at least one water outlet portion being in communication with a water outlet end of the water supply pipeline and configured to spray water in a sweeping motion to the heat generation region corresponding to the water outlet portion.

2. The energy storage apparatus according to claim 1, wherein the water outlet portion comprises at least one water spraying head rotatably disposed in the box and configured to spray water to at least two of the plurality of heat generation devices in the heat generation region corresponding to the water outlet portion.

3. The energy storage apparatus according to claim 2, wherein each of the at least one water spraying head comprises:
a main portion rotatably disposed in the box, the main portion defining a main cavity, the main cavity being in communication with the water outlet end of the water supply pipeline; and
a plurality of blades circumferentially arranged at an outer wall of the main portion, each of the plurality of blades having an auxiliary cavity in communication with the main cavity, each of the plurality of blades having at least one water spray hole at a surface of the blade, and the at least one water spray hole being in communication with the auxiliary cavity.

4. The energy storage apparatus according to claim 3, wherein the water outlet portion comprises a plurality of water spraying heads arranged at intervals in a direction in which the plurality of heat generation devices is arranged, where 1<A<M, wherein A represents a total number of water spraying heads of the water outlet portion, and M represents a total number of the heat generation devices in the heat generation region corresponding to the water outlet portion.

5. The energy storage apparatus according to claim 1, wherein the water outlet portion comprises a plurality of water outlet holes, the plurality of water outlet holes being arranged at the water supply pipeline at intervals in a direction in which the plurality of heat generation devices is arranged.

6. The energy storage apparatus according to claim 1, wherein the at least one heat generation module comprises a plurality of heat generation modules and the at least one water outlet portion comprises a plurality of water outlet portions, the plurality of heat generation modules being in a one-to-one correspondence with the plurality of water outlet portions, and the plurality of water outlet portions being arranged at intervals in a direction in which the plurality of heat generation modules is arranged.

7. The energy storage apparatus according to claim 6, wherein the water supply pipeline comprises:
a water delivery pipeline; and
a plurality of water spraying pipelines in a one-to-one correspondence with the plurality of heat generation modules, each of the plurality of water spraying pipelines having a water outlet end in communication with a water outlet portion and a water inlet end in communication with a water outlet end of the water delivery pipeline.

8. The energy storage apparatus according to claim 6, wherein the water supply pipeline comprises:
a water delivery pipeline; and
a water spraying pipeline, the water spraying pipeline being of zigzag shape, each of the plurality of water outlet portions being in communication with a water outlet end of the water spraying pipeline, and the water spraying pipeline having a water inlet end in communication with a water outlet end of the water delivery pipeline.

9. The energy storage apparatus according to claim 1, further comprising:
at least one detector disposed in the box and configured to detect environmental information of at least one heat generation region;
a water supply pump configured to drive water to flow into the water supply pipeline; and
a controller electrically connected to the detector and the water supply pump, the controller being configured to control the water supply pump based on the environmental information.

10. An energy storage system, characterized in comprising:
a power generator; and
the energy storage apparatus according to claim 1,
wherein the energy storage apparatus is electrically connected to the power generator.

11. The energy storage system according to claim 10, wherein the water outlet portion comprises at least one water spraying head rotatably disposed in the box and configured to spray water to at least two of the plurality of heat generation devices in the heat generation region corresponding to the water outlet portion.

12. The energy storage system according to claim 11, wherein each of the at least one water spraying head comprises:
a main portion rotatably disposed in the box, the main portion defining a main cavity, the main cavity being in communication with the water outlet end of the water supply pipeline; and
a plurality of blades circumferentially arranged at an outer wall of the main portion, each of the plurality of blades having an auxiliary cavity in communication with the main cavity, each of the plurality of blades having at least one water spray hole at a surface of the blade, and the at least one water spray hole being in communication with the auxiliary cavity.

13. The energy storage system according to claim 12, wherein the water outlet portion comprises a plurality of water spraying heads arranged at intervals in a direction in which the plurality of heat generation devices is arranged, where 1<A<M, wherein A represents a total number of water spraying heads of the water outlet portion, and M represents a total number of the heat generation devices in the heat generation region corresponding to the water outlet portion.

14. The energy storage system according to claim 10, wherein the water outlet portion comprises a plurality of water outlet holes, the plurality of water outlet holes being arranged at the water supply pipeline at intervals in a direction in which the plurality of heat generation devices is arranged.

15. The energy storage system according to claim 10, wherein the at least one heat generation module comprises a plurality of heat generation modules and the at least one water outlet portion comprises a plurality of water outlet portions, the plurality of heat generation modules being in a one-to-one correspondence with the plurality of water outlet portions, and the plurality of water outlet portions being arranged at intervals in a direction in which the plurality of heat generation modules is arranged.

16. The energy storage system according to claim 15, wherein the water supply pipeline comprises:
a water delivery pipeline; and
a plurality of water spraying pipelines in a one-to-one correspondence with the plurality of heat generation modules, each of the plurality of water spraying pipelines having a water outlet end in communication with a water outlet portion and a water inlet end in communication with a water outlet end of the water delivery pipeline.

17. The energy storage system according to claim 15, wherein the water supply pipeline comprises:
a water delivery pipeline; and
a water spraying pipeline, the water spraying pipeline being of zigzag shape, each of the plurality of water outlet portions being in communication with a water outlet end of the water spraying pipeline, and the water spraying pipeline having a water inlet end in communication with a water outlet end of the water delivery pipeline.

18. The energy storage system according to claim 10, further comprising:
at least one detector disposed in the box and configured to detect environmental information of at least one heat generation region;
a water supply pump configured to drive water to flow into the water supply pipeline; and
a controller electrically connected to the detector and the water supply pump, the controller being configured to control the water supply pump based on the environmental information.
